(19) United States
(12) Patent Application Publication
(10) Pub. No.: US 2003/0186652 A1
(43) Pub. Date: Oct. 2, 2003

(54) System and method for transmitting signals in vehicles

(76) Inventors: Bernd Peter Hopf, Dinslaken (DE); Yusuf Kalayci, Duisburg (DE); Claus-Peter Meyer-Bothling, Bocholt (DE); Uwe Schwark, Bocholt (DE); Michael Tolk, Bocholt (DE)

Correspondence Address: BELL, BOYD & LLOYD, LLC, P. O. BOX 1135, CHICAGO, IL, 60690-1135, US

(21) Appl. No.: 10/362,244

(22) PCT Filed: Jul. 31, 2001
(86) PCT No.: PCT/DE01/02909

(30) Foreign Application Priority Data
Aug. 17, 2000 (DE) 10040238.0

(51) Int. Cl. H04B 5/00

(52) U.S. Cl. 455/41.2

(57) ABSTRACT

The invention relates to a system for unidrectional or bi-directional signal transmission between at least two elements (E1, E2), which constitute components of an electric power supply and signal transmission system (EVS) of vehicles. According to the invention, one of the elements (E1) is connected to at least one Bluetooth radio module (B1) and one of the other elements (B2) is connected to at least one Bluetooth radio module (B2). The unidirectional or bi-directional signal transmission between the elements (E1) and (E2) and to the Bluetooth radio modules (B1, B2) takes place via an electric cable, but is wireless between the Bluetooth radio modules (B1, B2). Several elements (E1, E2) that are connected to Bluetooth radio modules (B1, B2) can be combined to form a Bluetooth pico-network. The Bluetooth radio modules (B1, B2) permit bi-directional signal transmission. A maximum of eight Bluetooth radio modules (B1, B2) can transmit signals to each other in a Bluetooth pico-network.

The invention relates to an arrangement and a method for transmitting signals electrically between at least two elements which are components of an electrical supply and signal transmission system of, for example, vehicles, aircraft or ships or are units which are assigned to the vehicles, aircraft or ships, one of the two elements generating an electrical signal and the other element being addressed by the electrical signal.

It is generally known that cable harnesses which have a length of kilometers and which weigh kilos are laid in supply and signal transmission systems, for example in motor vehicles, and the function of said cable harnesses is difficult to assign, in particular during maintenance and servicing work, and it is also known that faults in the electrical lines can only be located and eliminated by expending a large amount of time. It is even perfectly customary to eliminate faults by relaying electrical lines. If functional changes in individual components are to be brought about within the electrical supply and signal transmission system, for example the use of separate rear lights to indicate changes in direction and braking in contrast to the use of the same rear light to indicate changes in direction and braking, this can only be achieved by rewiring.

In recent years, the number of components for data acquisition, such as sensors, for processing data, such as microcontrollers, and for outputting data, such as display elements, actuating motors etc., which are installed in motor vehicles, for example, has been increasing continuously. Accordingly, the length of cable, for example for connecting the components in motor vehicles, has continued to increase, which, apart from the increased expenditure on fault recovery and maintenance already described, involves additional increased recycling work.

The design and the method of operation of an arrangement composed of elements within the electrical supply and signal transmission network are to be explained in more detail by means of an example, in this case a motor vehicle. An element, for example an operating lever, is activated in order to display a change in the direction of travel. The element is linked to one or more other elements, for example an indicator flasher light. The indicator flasher light is activated or deactivated by activating the operating lever.

The object of the present invention is to specify an arrangement according to the preamble of claim 1 with respect to the installation of elements which have been explained by way of example, and a method for transmitting signals between the elements, so that the cable length is reduced, and so that the expenditure on fault recovery, maintenance, servicing and recycling is reduced.

The object which relates to the arrangement is achieved by means of the defining part of claim 1 and the object relating to the method is achieved by means of the defining part of claim 10.

According to the invention, the elements are each connected to a radio module which operates according to the Bluetooth standard, referred to below as Bluetooth radio module, by means of an electrical line for the electrical transmission of signals or voice. A first element conducts the generated electrical signal to a first Bluetooth radio module (the master) which transmits the electrical signal in a wire-free fashion to a second Bluetooth radio module (slave) or to a plurality of Bluetooth radio modules (slaves), the second Bluetooth radio module (the slave) feeding the received signal to the assigned element.

Bluetooth modules and nodes are known per se and have been described, for example, under the title: “Das Bluetooth-Konzept [The Bluetooth concept]” by Eric Meyer in the publication “Funkschau” 9/99, pp. 34-38.

A significant advantage of the invention is that the cable length can be reduced by using Bluetooth radio modules for transmitting signals between a first element and a second element. This is of enormous significance as, for example in the application case of a vehicle, signals are transmitted between a multiplicity of elements and the potential for reducing the cable length is accordingly very high. Through the wire-free transmission via the Bluetooth radio modules it is possible to span up to 10 meters, and even up to several hundred meters if Bluetooth radio modules with higher transmission powers are used. It is anticipated that it will be possible to manufacture Bluetooth radio modules in a cost-effective way, and in several years a sales price of 5 US$ per Bluetooth radio module should be achievable.

A further significant advantage of the invention is that an arrangement composed of Bluetooth radio modules permits a point-to-multipoint connection so that an element which is connected to a Bluetooth radio module can transmit signals simultaneously to a plurality of elements which are also connected in each case to a Bluetooth radio module.

Further features and advantages of the invention emerge from the following description which explains the invention by means of a plurality of exemplary embodiments and in conjunction with the appended drawings, in which, in a schematic view,

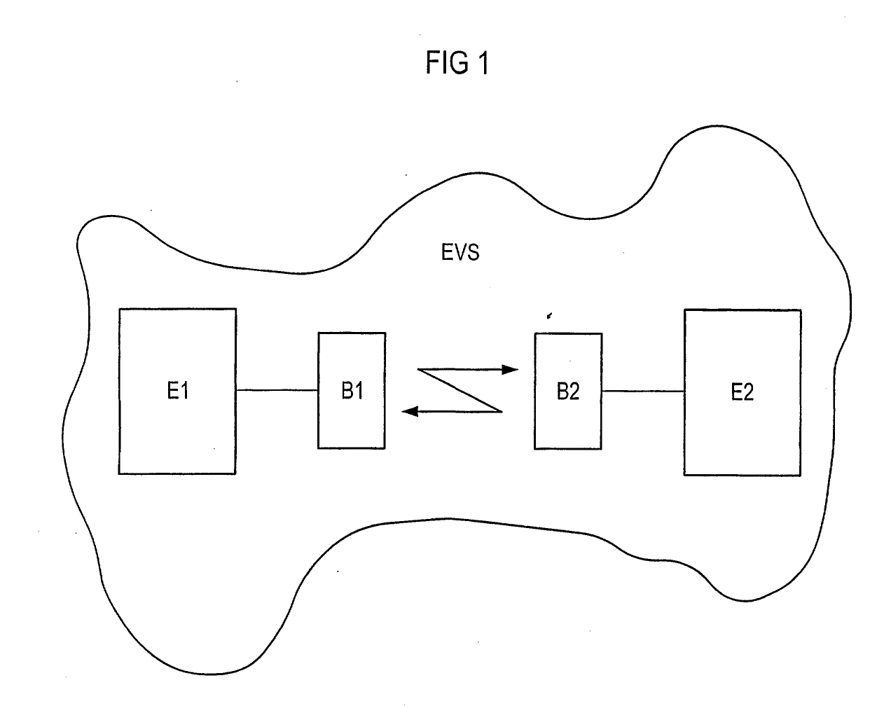

FIG. 1 shows an arrangement within an electrical supply and signal transmission system having two elements and two Bluetooth radio modules which are connected to the elements via an electrical line,

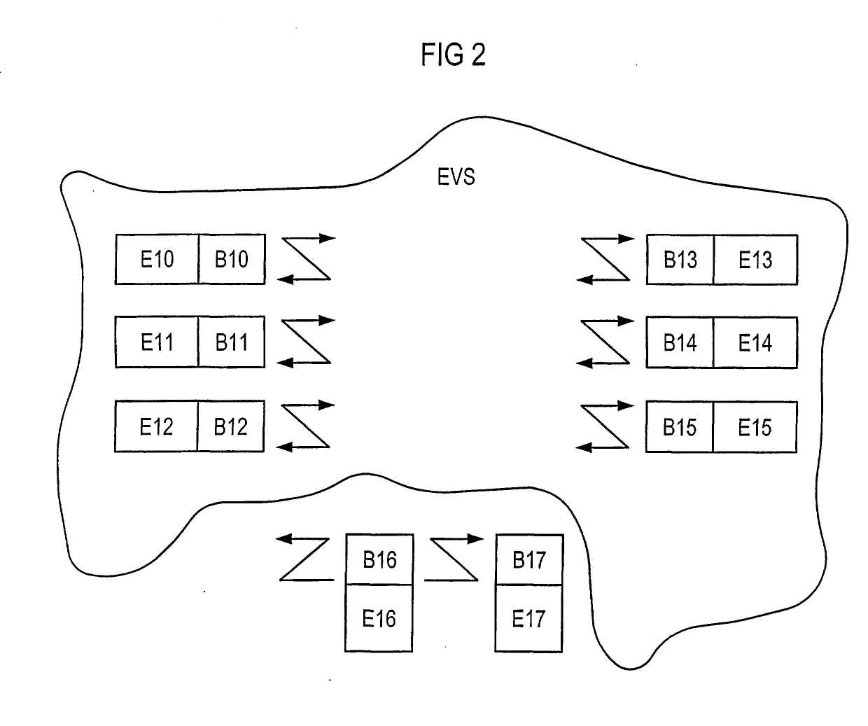

FIG. 2 shows an arrangement composed of a plurality of elements into which Bluetooth radio modules are integrated, inside and outside an electrical supply and signal transmission system, and

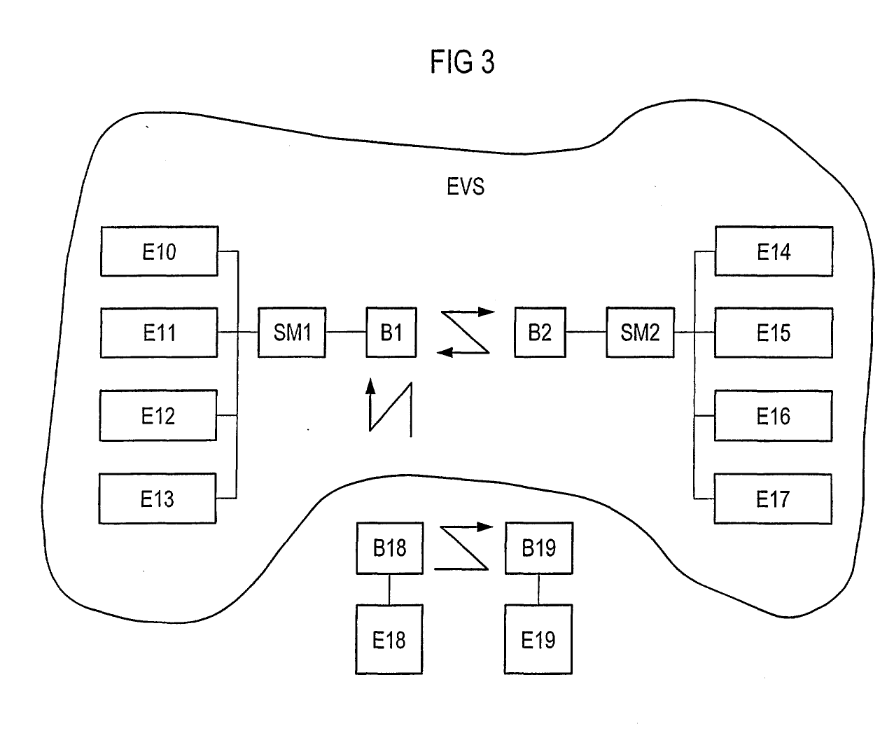

FIG. 3 shows an arrangement composed of a plurality of elements and Bluetooth radio modules which are connected to the elements via control modules.

In FIG. 1, there is an arrangement composed of a first element E1, a second element E2 and a first and second Bluetooth radio module B1 and B2, respectively, which are located within an electrical supply and signal transmission system EVS of a vehicle. The first element E1 is embodied as an operating lever which is activated mechanically and generates an electrical signal. It is referred to as a signal-triggering element. The electrical signal is transmitted to the first Bluetooth radio module B1 via an electrical line. The electrical signal is converted there and irradiated as an electromagnetic signal. The second Bluetooth radio module B2 receives the electromagnetic signal which is emitted by the first Bluetooth radio module B1 and converts it into an electrical signal. The electrical signal is transmitted by the second Bluetooth radio module B2 via an electrical line to the second element E2 which is embodied as a lamp. The lamp is switched on and off by the received electrical signal. The second element is referred to as an addressed element.

The wire-free transmission of signals between the first and second Bluetooth radio modules B1 and B2 is carried out in the 2.4 GHz (ISM) frequency band. This frequency band is a frequency band which is released worldwide for Bluetooth applications. Restrictions on the frequency band in some countries is described in the “Specification of the Bluetooth-System” from the Bluetooth Special Interest Group on the Internet site www.bluetooth.com.

The operating lever is located in the interior of the vehicle and the lamp on the front of the vehicle. A distance of 1.5 to 2 m is therefore to be spanned in a wire-free fashion. Bluetooth modules are designed for ranges up to 10 m and can therefore be used for applications in a vehicle. Even in applications in long vehicles such as trucks with trailers it is possible for a lamp E2 which is connected to a Bluetooth radio module B2 to be addressed by the operating lever E1 in a wire-free fashion via the Bluetooth radio module B1 as the use of a Bluetooth radio module B1 with a relatively high transmission power of 20 dBm itself permits ranges of several hundred meters.

The Bluetooth radio modules B1 and B2 do not need to be directly opposite one another as they can emit signals in a wide spatial area and receive signals from a wide spatial area. Even nonmetallic objects between the Bluetooth radio modules B1 and B2 do not significantly disrupt the transmission of signals. The intended addressing of the Bluetooth radio module B2 by the Bluetooth radio module B1 is possible because each Bluetooth radio module B1, B2 has a 48-bit MAC address which is uniquely defined throughout the world. The security standard for the transmission of signals is increased by virtue of the fact that the signal is transmitted between the Bluetooth radio modules B1 and B2 in encrypted form.

The Bluetooth radio modules B1, B2 are configured for a bidirectional transmission of signals. The maximum data transmission rate between the Bluetooth radio modules B1 and B2 of 721 kbit/s on the main channel or 57.6 kbit/s on the back channel (half duplex operating mode) or of up to 432 kbit/s in both directions in the full duplex operating mode is more than sufficient for the requirements for the transmission of signals between a signal-triggering element E1 and an element E2 which is addressed by means of the signal.

Bluetooth radio modules B1, B2 can be configured for the master/slave operation. An element E1, the master, which is embodied as an operating lever activates or deactivates an element E2, the slave, which is embodied as an indicator flasher lamp, via the Bluetooth radio module B1 connected to the element E1, and the Bluetooth radio module B2 connected to the element E2. An element E2 which is addressed can also generate an acknowledgement. If the element E2 is embodied as an indicator flasher lamp, in the event of a defect it transmits a signal via the Bluetooth radio module B2 and the Bluetooth radio module B1 to an element E1 which is embodied as a display unit, or an element E1 which is embodied as an operating lever with warning device. The defective element E1 can thus be replaced immediately, thus increasing traffic safety.

Furthermore, the Bluetooth radio modules B1, B2 can be placed in a sleep mode in order to reduce their energy consumption and/or carry out interrogations at regular or irregular times. An element E2 which is embodied as a tire-pressure sensor or tire-temperature sensor could be addressed by an element E1 which is embodied as a control device, via the Bluetooth radio modules B1 and B2, which are woken up hourly. If the values which are sensed by the tire-pressure sensor or tire-temperature sensor E2 are higher than defined limiting values, the tire-pressure sensor or tire-temperature sensor E2 signals this upward transgression of the limiting values to the control device E1 which indicates this upward transgression to the driver.

The described interrogations can be used for making statistical recordings of measured values and processing them.

As the Bluetooth radio modules B1, B2 are very small and may be only low in weight they may likewise be integrated into the elements E1, E2 or form one unit with them.

As a result of the fact that the element E1 and the Bluetooth radio module B1 or the element E2 and the Bluetooth radio module B2 can be of modular design, if an element E1 is destroyed the Bluetooth radio module B1 is re-used for making the connection to a new, undestroyed element E1. The construction of an arrangement of the element E1 and of the Bluetooth radio module B1 as a modular structure makes separation, i.e. recycling, easier.

Arrangements of described elements E1 and E2 or of Bluetooth radio modules B1 and B2 which are connected to them are conceivable for a multiplicity of applications in the vehicle. E1 and E2 can be embodied as switches and indicator flasher lights, push-button keys and headlights, as an ignition key device or central locking device composed of transmitter and receiver, sensor and switch, switches and elements of the lighting system, measuring instruments and regulating device and the like.

An arrangement composed of a first element E1, a Bluetooth radio module B1 which is connected to the element E1, a second element E2 and a Bluetooth radio module B2 which is connected to the element E2 can also be used in aircraft and ships, said arrangement being a component of an electrical supply and signal transmission system EVS.

FIG. 2 shows an arrangement composed of a plurality of elements E10 to E17 with Bluetooth radio modules B10 to B17 which form one unit these elements and which are located inside and outside the electrical supply and signal transmission system EVS of a vehicle. The element E10 is embodied as a switch, the element E11 as the brake pedal, the element E12 as a push-button key, the element E16 as a handheld transmitter, the element E17 as a garage door, the element E13 as an indicator flasherlight, the element E14 as a brake light and the element E15 as a central locking system. The activation/deactivation of the indicator flasher light E13 is carried out by means of the switch E10 via the Bluetooth radio modules B10 and B13 which form one unit with the elements.

The activation/deactivation of the brake light E14 is carried out by activating the gas pedal E11 via the Bluetooth radio modules B11 and B14. The push-button key E12, which is located within the vehicle, releases/locks the central locking system E15 via the Bluetooth radio modules B12 and B15, in order to protect children. On the other hand, the central locking system E15 can also be released and locked by the handheld transmitter E16 by means of the Bluetooth radio modules B16. The handheld transmitter E16 also opens/closes a garage door E17 by transmitting signals via the Bluetooth radio modules B16 and B17.

The elements E16, E17 and the Bluetooth radio modules B16, B17 which form one unit with them are not a component of the electrical supply and signal transmission system EVS of the vehicle but are defined as units which are assigned to the vehicle.

The Bluetooth radio module B16 transmits signals both to the Bluetooth radio module B15 and to the Bluetooth radio module B17. It uses the point-to-multipoint functionality of the Bluetooth radio modules, which means in a Bluetooth pico-network it is possible for up to eight Bluetooth radio modules to transmit signals to one another simultaneously. The functionality of the point-to-multipoint connection between the Bluetooth radio modules is not supported by other radio networks, for example by systems in the ISM bands 433 MHz and 868 MHz.

Signal transmission errors between the elements can be detected more quickly. This is made possible by virtue of the fact that individual Bluetooth radio modules can be actuated selectively by means of test software and their transmission behavior can be checked. A fault detection routine can also be implemented in the test a software.

In Germany it is customary for the indication of a change of direction and braking to be carried out with different rear lights which are embodied as elements E13 and E14.

Accordingly, signals are transmitted between the Bluetooth radio modules B10 to B13 and B11 to B14. In contrast, in the USA, the indication of a change of direction and braking is carried out with the same element E13 which is embodied as a rear light, which means that both the Bluetooth radio module B10 and the Bluetooth radio module B11 transmits signals to the Bluetooth radio module B13. The electrical transmission of signals between the Bluetooth radio modules B10, B11, B13 and B14 is changed by inputting into a software package. Costly recabling is thus avoided.

FIG. 3 shows an arrangement composed of a plurality of elements E10 to E17, Bluetooth radio modules B1 and B2 which are connected to the elements via control modules SM1, SM2 and which are located within an electrical supply and signal transmission system EVS of a vehicle, and two elements E18, E19 each with a connected Bluetooth radio module B18, B19 which are located outside the electrical supply and signal transmission system EVS of the vehicle, but are to be considered as units which are assigned to the vehicle. The element E10 is a switch, the element E11 an indicator lamp, the element E12 a push-button key, the element E13 a voice module, the element E14 an indicator flasher light, the element E15 a sensor for monitoring tire pressure, the element E16 a central locking system, the element E17 an actuating motor for opening the engine hood, the element E18 a handheld transmitter and the element E19 a garage door. The activation/deactivation of the indicator flasher light E14 is carried out by activating the switch E10, the electrical signal which is generated by the switch E10 being passed on via an electrical line to the control module SM1 and from there to the Bluetooth radio module B1 via an electrical line. The Bluetooth radio module B1 converts the electrical signal into an electromagnetic signal and emits it. The Bluetooth radio module B2 receives the signal which is emitted by the Bluetooth radio module B1, converts it into an electrical signal, and passes it on via an electrical line to the control module SM2. The control module SM2 then conducts the electrical signal via an electrical line to the indicator flasher light E14 which is as a result activated/deactivated. In a similar way, an electrical signal which is generated by the sensor E15 is transmitted to the display lamp E11 via the control module SM2, the Bluetooth radio modules B2 and B1 and the control module SM1, and an electrical signal generated by the push-button key E12 is transmitted to the central locking system E17 via the control module SM1, the Bluetooth radio modules B1 and B2 and the control module SM1, or from the voice module E13 to the actuating motor E16 for opening the engine hood. The handheld transmitter E18 generates an electrical signal which is passed on to the Bluetooth radio module B18 via an electrical line. The signal is passed on via the Bluetooth radio modules B1, B2 and the control module SM2 to the central locking system E17 for releasing/opening it and via the Bluetooth radio module E19, connected to the garage door E19, for opening/closing the garage door E19. The control modules SM1 and SM2 connect the generated electrical signal of an element to one or more further elements that are provided. The control modules SM1 and SM2 accordingly decide which elements signals are being transmitted between.

1. An arrangement for transmitting signals in vehicles, the arrangement comprising at least two elements (E1, E2) between which signals are electrically transmitted and which are components of an electrical supply and signal transmission system (EVS) of the vehicle or are units which are assigned to the vehicle, characterized in that one of the elements (E1) is connected to at least one Bluetooth radio module (B1), another element (E2) is connected to at least one Bluetooth radio module (B2), and in that signals are transmitted unidirectionally or bidirectionally between the Bluetooth radio modules (B1) and (B2).

2. The arrangement as claimed in claim 1, characterized in that one of the elements (E1) is a signal-triggering element, and another element (E2) is an element which is addressed by the signal.

3. The arrangement as claimed in one of the preceding claims, characterized in that the Bluetooth radio module (B1) forms one unit with the element (E1), or the Bluetooth radio module (B2) forms one unit with the element (E2).

4. The arrangement as claimed in one of the preceding claims, characterized in that the arrangement carries out a master-slave operation, one of the elements (E1) being the master which activates or deactivates another element (E2), the slave.

5. The arrangement as claimed in one of the preceding claims, characterized in that the element (E2) which was activated by an electrical signal which is generated by the element (E1) and is passed on via the Bluetooth radio modules (B1, B2) generates itself an electrical signal as acknowledgement, which is passed on via the Bluetooth radio modules (B1, B2) to the element E1 which processes the electrical signal.

6. The arrangement as claimed in one of the preceding claims, characterized in that the Bluetooth radio module (B1) is connected to a control module (SM1), and the Bluetooth radio module (B2) is connected to a control module (SM2) in order to transmit signals electrically, in that the control module (SM1) is connected to a plurality of elements (E10, E11, E12, E14), and the control module (SM2) is connected to a plurality of elements (E14, E15, E16, E17), also in order to transmit signals electrically, the control modules (SM1, SM2) bringing about the desired transmission of signals between an element (E10, E11, E12, E13) and one or more elements (E14, E15, E16, E17) or an element (E14, E15, E16, E17) and one or more elements (E10, E11, E12, E13).

7. The arrangement as claimed in one of the preceding claims, characterized in that a multiplicity of Bluetooth radio modules (B1, B2) which are each connected to elements (E1, E2) form a Bluetooth pico-network, signals being transmitted between the elements (E1, E2) within the scope of a point-to-point connection and of a point-to-multipoint connection.

8. The arrangement as claimed in one of the preceding claims, characterized in that signal transmission errors between the elements (E1, E2) of the arrangement are detected by means of a test software package which can contain an error detection routine, the Bluetooth radio modules (B1, B2) being activated, and their behavior tested, by means of the test software package.

9. The arrangement as claimed in one of the preceding claims, characterized in that by means of inputting into a software package it is possible to detect which Bluetooth radio modules (B) transmit signals to one another.

10. A method for transmitting signals between at least two elements (E1, E2) which are components of an electrical supply and signal transmission system (EVS) of vehicles or units which are assigned to the vehicle, characterized in that the signal is transmitted from the element (E1) to the Bluetooth radio module (B1) via an electrical line, from the Bluetooth radio module (B1) to the Bluetooth radio module (B2) in a wire-free fashion, from the Bluetooth radio module (B2) to the element (E2) via the electrical line, or in the reverse order from the element (E2) to the Bluetooth radio module (B2) via the electrical line, from the Bluetooth radio module (B2) to the Bluetooth radio module (B1) in a wire-free fashion, and from the Bluetooth radio module (B1) to the element (E1) via the electrical line.
